(19) United States
(12) Patent Application Publication
(10) Pub. No.: US 2015/0301624 A1
(43) Pub. Date: Oct. 22, 2015

(54) INPUT SYSTEM USING ELECTRONIC PEN

(71) Applicant: Seung Hee LEE, Suwon-si (KR)

(72) Inventor: Seung Hee LEE, Suwon-si (KR)

(21) Appl. No.: 14/421,629

(22) PCT Filed: Aug. 23, 2013
(86) PCT No.: PCT/KR2013/007589

§ 371 Date: Feb. 13, 2015

(30) Foreign Application Priority Data
Sep. 4, 2012 (KR) 10-2012-0097537

(51) Int. Cl. G06F 3/03; H04N 5/225; G06F 3/0354

(52) U.S. Cl. CPC G06F 3/0321; G06F 3/03545; H04N 5/225

(57) ABSTRACT

More particularly, the present invention relates to an input system using unit patterns representing absolute coordinate information and an electronic pen that may recognize the patterns. The input system using the electronic pen according to the present invention includes: a coordinate pattern sheet on which a plurality of unit patterns representing absolute coordinate information are arranged; a pen tip moving on the coordinate pattern sheet; an electronic pen including a camera having a range of vision in which the pen tip and at least one of the unit patterns may be recognized together; and a controller obtaining absolute coordinate information on the unit pattern recognized by the camera, calculating the relative coordinates of the pen tip based on the unit pattern through the location of the pen tip and the location of the unit pattern recognized by the camera, adding up the relative coordinates of the pen tip and the absolute coordinates of the unit pattern, and calculating the absolute coordinates of the pen tip. The input system using the electronic pen according to the present invention may very easily make all surfaces, in addition to a display unit such as a computer monitor or a mobile terminal display, function as an input unit similar to a touch panel.

### BACKGROUND OF THE INVENTION

1. Field of the Invention

This is an invention is an input system, in more detail, an input system using an electronic pen capable of recognizing the unit patterns presenting absolute coordinate data.

2. Description of the Prior Art

This invention relates to the input methods for electronic equipment such as computers, cellphones, and others. In the past, such input systems were mostly based on a keyboard or a mouse, but in these days, touch-screens are more commonly used.

Touch screens are a substituting input system for an input system of a mouse or keyboard that enables users to precede an input system using a hand or pen. A touch-screen input system allows users to precede their duties at demand while watching the screen. Because it is user-friendly, this input system is recognized as the most ideal input system under the GUI (Graphical User Interface) environment, thus the touch-screen input system is widely used in various field devices such as cellphones, PDAs, the devices at banks or government offices, various medical equipment, and information boards for tourists.

Furthermore, Patent Publication No. 2010-52526 refers to a different input system that comprises a data processing system allowing an input system similar to a touch panel, wherein the dot patterns are received by using optical recognition device after attaching the transparent sheet with dot patterns including the absolute coordinate data presented on the display of an electronic device.

### Technical Objectives

This invention relates to an input system using traditional dot patterns previously described using optical recognition devices for receiving and directly using the absolute coordinate data including coordinate patterns to recognize the positions of optical recognition devices.

Therefore, in order to acquire an accurate and detailed input, the coordinate patterns must be very densely arranged. For instance, if one prints the coordinate pattern at 300 dpi, the interval of the arranged coordinate pattern must be approximately 84 μm. Such a densely arranged coordinate pattern may decrease transparency. In addition, the forms of coordinate patterns become complicated and the sizes become so small that it is more difficult to develop coordinate patterns. Also, even after developing coordinate patterns, there is a great possibility that the developed film of the coordinate pattern can be modified during the procedures such as coordinate pattern printing, protective lamination and others. Moreover, it is possible to make errors by dozens of μm during the film adhering process; thus, it is difficult to apply.

In particular, it is difficult to develop an input system that handles the high degree of precision of coordinate pattern are formed in such high resolution of 600 dpi.

This invention is developed for improving the discussed problems by using a minimum number of coordinate patterns to provide an accurate and detailed input system of an electronic pen.

Furthermore, this invention is developed for providing an input system of an electric pen that could be easily applied on the touch screens using the existing resistive overlay method capacitance method.

### Problem-Solving Methodology

In order to achieve the described purposes, this invention comprises an input system using an electric pen that comprises an coordinate pattern sheet where a plurality of units patterns are arranged for presenting the absolute coordinate data, a pen tip that moves around on top of the aforesaid coordinate pattern sheet, an electric pen with a camera with a field of view (FOV) simultaneously recognizing at least one of the aforesaid unit patterns or the pen tip, and a controller that calculates the absolute coordinates of the aforesaid pen tip by acquiring the absolute coordinate data of the aforesaid unit patterns recognized by the aforesaid camera, calculating the relative coordinates of the aforesaid pen tip based on the aforesaid unit patterns recognized by the locations of the pen tip and the unit patterns from the aforesaid camera, and adding the relative coordinates of the pen tip and the absolute coordinates of the unit patterns.

The aforesaid unit patterns comprise the points of axis directions that present the x-axis and y-axis directions based on the center-points that are configured by the prescribed algorithm in identifying the mid-points, the XY absolute coordinate, and the XY direction data when calculating the aforesaid pen tip and the relative coordinate to set the base points.

The aforesaid pattern sheet comprises a plurality of unit coordinate pattern sheets, and each unit coordinate pattern sheet is arranged by the aforesaid pen tip, the center-point which is a base point for calculating the relative coordinates, and a plurality of unit patterns, including the axis direction marks arranged in X-axis and Y-axis directions centered at the center-point from a prescribed algorithm that presents the XY absolute coordinates and XY direction data of the aforesaid center-points. Each unit coordinate pattern sheet's center-points may have different formations.

The aforesaid coordinate pattern sheet may be a transparent film built by a plurality of unit patterns. Also, the aforesaid coordinate pattern sheet is the touch panel's printed film of transparent electrode patterns and the aforesaid coordinate pattern sheet may be formed with a combination of transparent electrode patterns and a plurality of unit patterns.

Furthermore, the input system using the aforesaid electronic pen is connected with the aforesaid pen tip and comprises a pressure sensor that measures the aforesaid pen tip's pressure. The aforesaid controller activates the aforesaid camera when the aforesaid pressure sensor recognizes any pressure.

In addition, the aforesaid camera has the FOV recognizing at least more than two of aforesaid unit patterns that when the aforesaid controller fails to receive the absolute coordinate data from one of selected unit patterns recognized by the images that the aforesaid camera acquires, the aforesaid controller issues alert signals and it is desirable to acquire another unit patterns' absolute coordinate data.

The aforesaid camera has the FOV recognizing at least more than two of aforesaid unit patterns that the aforesaid controller acquires at least two of unit patterns' absolute coordinate data recognized by the aforesaid camera and it is possible to receive XY-axis direction data of the recognized two unit pattern.

### BRIEF DESCRIPTION OF THE DRAWINGS

FIG. 1 is a diagram illustrating the embodiments of this invention, an input system using an electronic, in use by attaching the parts to the computer monitor and the plate.

FIG. 2 is a diagram illustrating a part of FIG. 1.

FIG. 3 is a diagram illustrating the status of the coordinate pattern sheet depicted in FIG. 2 when the infrared rays are detected

FIG. 4 is a diagram of an electronic pen drawn in FIG. 1

FIG. 5 is a diagram for explaining the calculation method for the absolute coordinates of the pen tip.

FIG. 6 is a diagram provides another embodiment of the invention relating the input system using an electronic pen by illustrating the application on a blackboard.

### DETAILED DESCRIPTION

This section provides detailed explanations of this invention referring to the accompanying drawings. However, this invention is not limited to the below-mentioned embodiments that it will be developed in various forms; thus, the embodiments only provide a complete starting point and category of this invention that is obvious for person of ordinary skill in the pertinent art.

The identical codes refer to identical components.

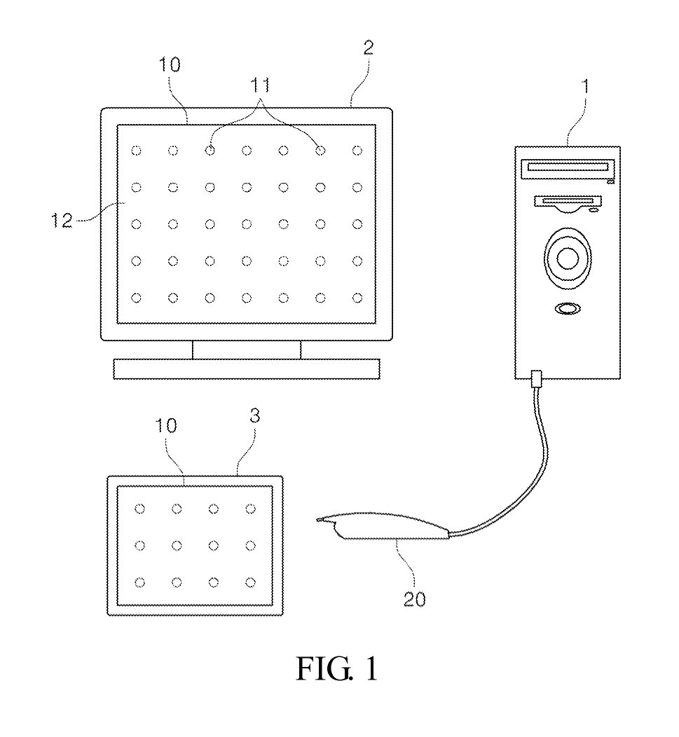

FIG. 1 is a diagram illustrating the embodiments of this invention, an input system using an electronic pen in use by attaching the parts to the computer monitor 2 and the plate.

In the reference to FIG. 1, the embodiments of the input system using an electronic system for this invention comprise the coordinate pattern sheet 10 and the electronic pen 20. In an embodiment, the coordinate pattern sheet 10 is attached to the computer monitor 2 and the plate 3. The coordinate pattern sheet 10 can be attached to the computer monitor 2 and the plate 3 with transparent adhesive. In FIG. 1, the unit patterns 11 of the coordinate pattern sheet 10 are marked, but it is desirable for the unit patterns 11, particularly the unit patterns 11 of the coordinate pattern sheet 10 attached to the computer monitor 2, to be transparent.

The coordinate pattern sheet 10 is built by a plurality of unit patterns 11 presenting the absolute coordinate data of the transparent film 12.

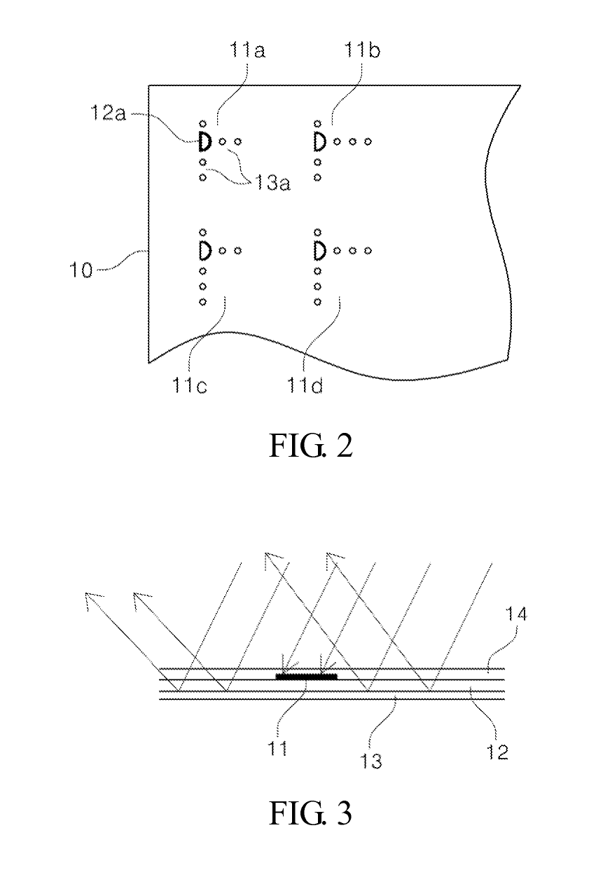

FIG. 2 is a diagram illustrating a part of FIG. 1.

As shown in FIG. 1, in an embodiment, the coordinate pattern sheet 10 comprises a plurality of unit patterns 11 arranged at constant intervals. The unit patterns 11 comprises the pen tip 22, the center-points 12 for using as the base point in calculating the relative coordinates, the axis direction points 13 arranged in X-axis and Y-axis directions basing the center-points 12 assigned by the prescribed algorithm presenting the XY absolute coordinates and XY-axis direction data of the center-points 12 in unit patterns 11. In an embodiment, the center-points 12 are drawn as semi-circles, but they can be in various forms such as triangles, rectangles, polygons, stars and others. The axis direction points 13 are drawn as circles, but the axis direction points 13 can also be in various shapes. The axis direction points 13 can be presented on the XY absolute coordinate by the shapes and numbers of the points, and the axis direction points 13 can be arranged in the directions according to the XY-axis directions.

The coordinate pattern sheet in FIG. 2 is merely an example that it can be presented in various arrangement. For instance, the arrangement can be in various publicly known code patterns such as the binary code and Gray code. Furthermore, instead of forming the center-points on the unit patterns 11 of the coordinate pattern sheet 10, this input system may recognize the base points of the unit patterns 11 by recognizing virtual centers from the images of unit patterns 11 via the camera 23.

In addition, although it is explained as if unit patterns 11 comprise XY-axis direction data, the unit patterns 11 only comprise the XY absolute coordinate data and XY-axis direction data can only be acquired by XY absolute data in a combination of two or more unit patterns 11. For example, if the absolute coordinates are 1,2, and 2,2 in two unit patterns 11, the line connecting the center-points of two unit patterns 11 becomes the Y-axis, and the unit patterns' direction of the absolute coordinate 2, 2 can be recognized as a positive direction. Also, as knowing the positive direction of the Y-axis, the direction of the a-axis can also be determined. In this case, the camera's FOV must be wide enough to receive more than two unit patterns.

The density of unit patterns is applied in the range that the FOV of the attached camera on the electronic pen 20 is capable of receiving two to four unit patterns. If the camera has the FOV of 6.4 mm×5.2 mm, the unit patterns in an arrangement of the 3 mm intervals are appropriate.

In an embodiment, as for the production materials of the transparent films 12, it is appropriate to use vinyl, vinyl chloride, PET (PolyEthylene Terephthalate), polypropylene film and other similar materials. Also, it can also be a thin glass plate.

As the medium of unit patterns 11 and transparent films 12 are different in reflectivity, penetration, absorption rates, the camera 23 easily distinguishes the transparent film 12 and unit patterns, but in order to increase the accuracy of image reading, as shown in FIG. 3, it is desirable to attach the coating layer 13 capable of reflecting infrared rays to the coordinate pattern sheets 10. Such oxidative materials capable of transmitting visible light and absorbing infrared light can be used for making the unit patterns 11. The protection film layers 12 may be built on the unit patterns for protecting the unit patterns 11. The unit patterns 11 can be produced by screen printing and other types of printing methods or photo lithography processes.

As shown in FIG. 3, in an embodiment, when infrared rays are detected on the coordinate pattern sheet 10, the infrared rays other than forming the unit patterns 11 are reflected and the infrared light on the unit patterns 11 is absorbed. Therefore, when infrared camera captures the coordinate pattern sheet 10, the portion that the unit patterns are built seem darker than the other parts.

Furthermore, inversely, the transparent films have the coating layers that absorb infrared rays, and the unit patterns are made of materials that reflect infrared rays. In this case, the area of the unit patterns reveals as lighter than other parts.

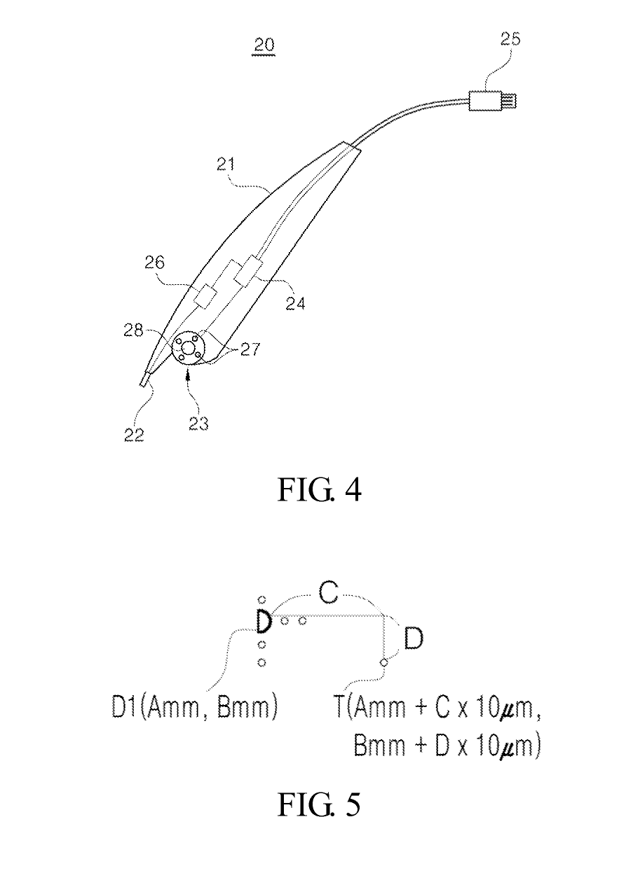

In an embodiment, the electronic pen 20 is connected to the computer 1. Referring to FIG. 4, the electronic pen 20 comprises the housing 21 that forms the exterior of the pen, pen tip 22, camera 23, controller 24 and communication module 25.

The pen tip 22 is at the end part of the electronic pen 20, which contacts the surfaces of the computer monitor 2 and the plate 3 while the electronic pen 20 is in use. The pen tip 22 is connected to the pressure sensor 26 that is also can be used as a switch. The pressure sensor 26 receives any pressure, it recognizes as the electronic pen is in use that it activates the camera 23. The pen tips 22 are also made of materials capable of absorbing infrared light similar to the unit patterns 11. Also, it can be manufactured with the materials that reflect infrared rays. In order to calculate the relative coordinates of the pen tip 22, the FOV of the camera 23 must recognize a combination of the unit patterns 11 and the pen tip 22. However, if the pen tip 22 is placed in the middle of the camera's FOV, it may disturb the image reading of the camera 23, it is desirable to place the pen tip 22 on one-side other than the middle of the camera 23's FOV. For instance, it can be placed at the boundary of the FOV. Furthermore, the lighting 27 can be installed on the pen tip 22.

The focus of the camera 23 is set at the center of the FOV. It is desirable to minimize any exterior effects of the materials, shapes or locations of the pen tip 22 to the camera 23. In an embodiment, the diagram shows that the lighting 27 is installed around the camera lens, but it can also be installed at the pen tip 22.

In an embodiment, the lighting 27 of the electronic pen 20 should be installed in a way that the light is not reflected by the lighting 27 when the lighting 27 of the electronic pen 20 is in use. It should be installed at the location that does not cause any problems with heat in taking images.

Furthermore, the camera 23 comprises the infrared light emitting diode (LED) 27 for detecting infrared rays and the Charge Coupled Device (CCD) 28 for converting the reflected light into electronic signals. The infrared LED 27 activates when there is pressure on the pressure sensor 26. The CCD 28 comprises from tens of thousands to billions of exposure data and the resolution is determined by the exposure data. Although the accuracy of the input system increases as the resolution of the camera 23, this invention still acquires a higher degree of accuracy compared to general touch panels even with the cameras of the 640×520 resolutions.

When the infrared light is detected in the infrared LED 27 and the detected infrared light is recognized on the coordinate pattern sheet 10, as shown in FIG. 3, the unit patterns 11 absorb infrared rays, and the parts other the unit patterns reflect the infrared light. The reflected infrared rays are inputted as exposure data. Also, the pen tip 22 made of the materials absorb infrared light also absorb infrared rays. Therefore, the camera 23 receives dark digital images from the unit patterns 11 and the pen tip 22.

In an embodiment, the controller 24 calculates the absolute coordinates based on the digital image input from the camera 23. The controller 24 may use the noise-free digital images by using digital filters. The controller 24 sends the calculated absolute coordinates of the pen tip 22 to the computer 1 through communication module 25. In the memory of the controller 24, there are various center points 12 of the unit patterns 11 in the forms of the unit patterns 11 saved on the absolute coordinate in table formats. The controller 24 processes the digital images inputted from the camera 24, recognizes the configurations of the unit patterns 11, and compares them with the saved data in memory for verifying the center-points 12 of the unit patterns 11′ absolute coordinates.

Furthermore, the controller 24 measures the location of the pen tip 22 by basing the center-points 12 received from the camera 23. Thus, in CCDs 28, the pixels between the center-points 12 and the pen tip 22 are counted that it is fast in calculating the relative coordinates of the pen tip 22 to the center points 12.

In addition, the absolute coordinates of the pen tip 22 are calculated by adding the relative coordinates of the pen tip 22 to the center-point 22 and the center-points 12 of the absolute coordinates. The fast processing speed is achieved by calculating the absolute coordinates with only the pixel counting between the received the unit patterns 11 and the pen tip 22 as the input system receives one of the unit patterns 11 and uses the received absolute coordinates until it disappears in the FOV of the camera 23.

In an embodiment, the camera's FOV is approximately 6.4 mm×5.2 mm, and if the resolution of the camera 23 is 640×52, the resolution of the X and Y-axes are 10 μm. This invention is capable of calculating the absolute coordinates of the pen tip 22 once the unit patterns 11 are in the range of the camera 23's FOV. However, it is possible to not recognize a part of unit patterns 11 when a part of the unit patterns 11 are damaged during the printing process or the surface of the monitor 2 is unclean. Therefore, it is desirable for the camera 23 to have the FOV that is capable of receiving two to four unit patterns 11. In an embodiment, the input system is able to calculate the absolute coordinates of the pen tip 22 based on another unit patterns 11 except the unrecognized ones. It is possible to verify the accuracy of the absolute coordinates by calculating the absolute coordinates of the pen tip 22 based on a plurality of unit patterns 11.

In an embodiment, It is desirable for a camera 23 to acquire the FOV capable of receiving more than two unit patterns 11 that are sized small in the case of the camera 23 becomes dirty with pollutants covering the FOV of the camera and distorting the unit patterns 11. It is easy for users to detect the pollutants and clean that this input system is user-friendly.

Therefore, as previously mentioned, it is desirable that the FOV of the camera 23 is 6.4 mm×5.2 mm and unit patterns 11 are arranged in 3 mm intervals. The unit patterns 11 are required to be a very detail-oriented input means with the resolution of 10 μm as the resolution of the X and Y axes are determined by the resolution of the camera 23; thus, the unit patterns 11 must be arranged in 3 mm intervals.

FIG. 5 shows the calculation method for the absolute coordinate of the pen tip. The absolute coordinate values of the unit pattern D1 are (A mm, B mm), the number of pixels between the pen tip T and the unit pattern D1 is presented as C and the absolute coordinates of the absolute coordinates of the pen tip T are (A mm+C×10 μm, B mm+D×10 μm).

In an embodiment, the communication module 25 is made for transferring the absolute coordinates of the pen tip 22 by connecting the electronic pen 20 to the computer 1, and it is connected onto I/O interfaces such as USB ports on the computer 1. FIG. 1 shows an example, but it can also be connected over wireless.

Furthermore, the electronic pen 20 may receive power via the USB port of the computer 1. When the electronic pen 20 is connected to the computer 1 over wireless using methods such as Bluetooth or Zigbee, the electronic pen 20 can be operated with the batteries inserted within the electronic pen 20.

The below section explains the methodology of calibration after the coordinate pattern sheet 10 is attached to the monitor 2. The user starts the calibration program after the coordinate pattern sheet 10 is attached to the monitor 2 and the user sees the dots at the four corners of the absolute coordinates that the calibration program automatically recognizes. Then, the user captures one of the dots on the absolute coordinates using the electronic pen 20. The captured image shows the recognized the dots of the absolute coordinate and the unit patterns 11 of the coordinate pattern sheet 11. The input system calculates the offset value by counting the pixels between the dot from the captured image and the unit patterns 11. Then, the offset value is applied for calculating the absolute coordinate of the pen tip 20 and transferred to the computer 1.

As previously mentioned, another coordinate pattern sheet 10 is also attached to the plate 3. The coordinate pattern sheet 10 attached to the plate 3 has almost identical functions to touch panels.

In the case of the coordinate pattern sheet 10 attaching to the plate 3, the functionality of the coordinate pattern sheet 10 is identical to the aforesaid coordinate pattern sheet 10 on the aforesaid monitor 2 except the fact that it is used as a touch pad rather than a touch screen. However, in the case of the plate 3, unlike the case of the monitor 2, the coordinate pattern sheet 10 does not have to be transparent. Nonetheless, in an embodiment, when the same electronic pen 20 is used for both the plate 3 and the monitor 2, it is desirable to use identical coordinate pattern sheets 10.

In this case, in order for the controller to distinguish the inputs to either the plate 2 or the monitor 2, it is desirable to attach coordinate pattern sheets 10 with different forms of center points 12 on the unit patterns 11.

Furthermore, the calibration method of the plate 3 is different to the one of the monitors 2.

First, the user locates the electronic pen 20 to the four corners of the coordinate pattern sheet 10 attached to the plate 3 and captures an image of the unit patterns 11 using the camera 23. Second, by the capture image, the input system measures the absolute coordinates of each unit pattern 11 and shows dots on each coordinate on the monitor 2 screen. Third, it calculates the distance between the dots on the monitor 2 and inputs the values to the calibration program. The program systemizes the absolute coordinates by matching the four corners of the coordinate pattern sheet 10 and the ones on the monitor 2 after comparing the values of the unit pattern 11 distances and the size of the computer monitor 2, In other words, the calibration program enables to alter the mismatch of the sizes of the plate and the monitor.

Although FIG. 1 shows the usage of the computer 1, monitor 2 and the plate 3, this invention is not limited for the usage on such devices. The input system can also be applied to any other devices such as PDA, televisions, cell phones, ATM, KIOSK, navigations, slot machines, and smart phones by attaching the coordinate pattern sheet and connecting the electronic pen to each device over wire or wireless that the input system is similar to the one of touch screens.

Furthermore, this input system is not limited to be placed on displays, but also to any types of surfaces by attaching printed film on the device surfaces that it can be used similarly to touch panels.

In addition, this input system also can be applied by not merely attaching the coordinate pattern sheet, but also by printing the unit patterns directly on a device surface and attaching the protection film.

Also, it is possible to print unit patterns on the films with transparent electrode patterns of touch panels using general resistive overlay or capacitance methods. It is convenient to produce the input system as it is possible to print the transparent electrode at once to build the unit patterns in the producing touch panels. This form of touch screens recognizes both input by hand or regular pen contacts as well as the electronic pen for inputting unit patterns.

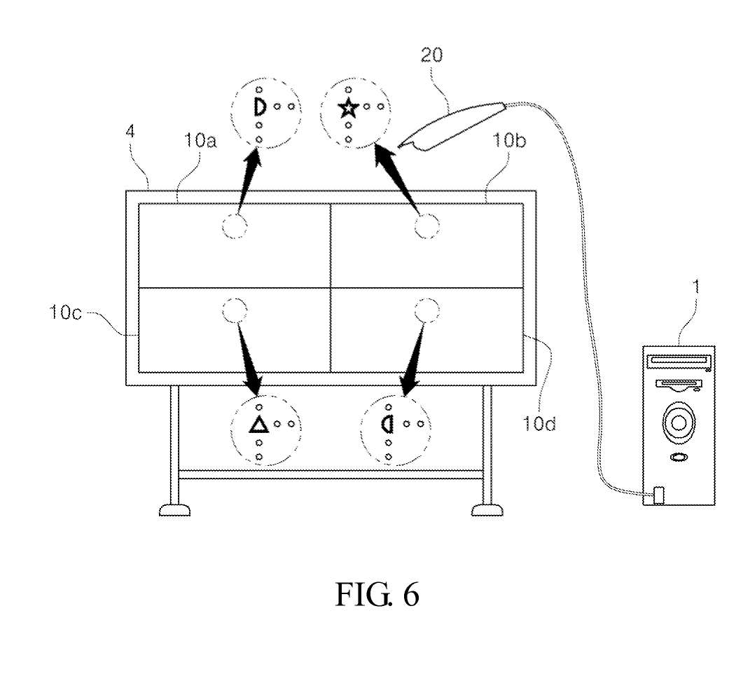

FIG. 6 is a diagram depicting another embodiment of the input system using the electric pen installed a blackboard. As the area of the blackboard 4 is extensive, a number of pattern sheet 10a-10d is attached. In this case, when the unit patterns sheets with an identical form are attached, the input system recognizes as they comprise the same absolute coordinate regardless of their positions. Therefore, the different forms of the center-code are used for the arrangement of a plurality of unit pattern sheets 10a-10d.

As shown in FIG. 6, the center-code of the unit pattern sheet in the upper left 10a is a right-filled semi-circle, the center-code of the unit pattern sheet at the upper right 10b is a star, the center-code the unit pattern sheet at the lower left 10c is a triangle, the center-code of the unit pattern sheet at the lower right 10d is a left-filled semi-circle. After attaching the unit pattern sheets with different center-codes 10a-10d like the ones in FIG. 6, the locations of each unit pattern sheet 10a-10d are recognized by the electronic pen and the applicable devices such as a computer 1 connected via wire or wireless and a smart with installed programs or apps that the entire area of the blackboard 4 can be used as a touch panel. Therefore, by attaching a number of unit pattern sheets 10a-10d on an ordinary blackboard 4, this input system may transform a regular blackboard 4 into an electronic blackboard for users.

Instead of a blackboard, a large LCD panel can be also used. Also, a plurality of LCD panels can be used as a large display. A plurality of LCD panels is controlled by a plurality of controllers that it can be used as a large computer screen.

The above explains the embodiments regarding the diagrams, but this invention may be altered and modified in various ways by technical experts for their needs under the scope of the patent claims.

For instance, the embodiment explained the controller is installed in the electronic pen, but the controller can also be used for cellphones or computers. Also, the pen tip is described as a switch, but other types of switches can be installed. In addition, one of the embodiments provides an example of using one electronic, but a plurality of electronic pens, which can be distinguished from each other by innate distinctive data, can be simultaneously used for entering data.

### REFERENCE NUMERALS

10 Coordinate pattern sheet
11 Unit pattern
12 Center-point
13 Axis direction point
20 Electronic pen
22 Pen tip
23 Camera
24 Controller
25 Communication module
26 Pressure sensor

### INDUSTRIAL APPLICABILITY

This invention relates an input system using an electronic pen, which develops input methods similar to widely-used touch panels for any displays such as computer monitors and cell phones. Furthermore, the input system is capable of accurate and detailed inputting using a minimum number of unit patterns.

What is claimed is:

1. An input system using an electronic pen comprising:
a coordinate pattern sheet with a plurality of arranged unit patterns presenting absolute coordinate data;
a pen tip moves around on the coordinate pattern sheet;
the electronic pen with a camera which comprises the field of view (FOV) capable of simultaneously recognizing at least one of the unit patterns and the pen tip; and
a controller for calculating the absolute coordinates of the pen tip by acquiring the absolute coordinate data recognized by the camera, calculating relative coordinates of the pen tip based on the absolute coordinates of the unit patterns by the locations of the pen tip and the unit patterns recognized by the camera, and adding the relative coordinates of the pen tip and the absolute coordinates of the unit patterns.

2. The input system using an electronic pen of claim 1, wherein the unit patterns comprise
center-points that are used as the base points in calculating the relative coordinates, XY absolute coordinates of the center-points, and
axis direction points based on the center-points presenting the XY-axes direction data received by a prescribed algorithm.

3. The input system using an electronic pen of claim 1, wherein the unit patterns comprise
axis direction points presenting the XY-absolute coordinates and XY-axes direction data of the unit patterns received from a prescribed algorithm,
the controller calculates the centers of the unit patterns by image processing of the unit patterns recognized by the camera, and
the electronic pen calculates the relative coordinates of the pen tip based on the center-points calculated by the controller.

4. The input system using an electronic pen of claim 1, wherein the coordinate pattern sheets comprise
a plurality of unit coordinate pattern sheets, each of the unit coordinate pattern sheet comprising a plurality of unit patterns with the base on the center-points arranged by a prescribed algorithm to present XY absolute coordinate data and center points, which provides the base for calculating the relative coordinates of the pen tip, the center points of each unit coordinate pattern sheet being used by different types of electronic pens.

5. The input system using an electronic pen of claim 1, wherein
the coordinate pattern sheet are made of transparent films built by a plurality of unit patterns.

6. The input system using an electronic pen of claim 1, wherein
the coordinate pattern sheet is a film on which transparent electrode pattern of a touch panel is printed and in the coordinate patterns, there are transparent electrode patterns and a plurality of unit patterns.

7. The input system using an electronic pen of claim 1, further comprises a pressure sensor connected to the pen tip, the pressure sensor measuring the pressure on the pen tip, and the controller that activates the camera when the pen tip does not apply any pressure.

8. The input system using an electronic pen of claim 1, wherein,
the camera has the FOV capable of simultaneously recognizing at least more than two unit patterns, and
the controller activates alert signals and acquires the absolute coordinate data from different unit patterns when the system fails to acquire the absolute coordinate data from one of selected unit patterns received in the images of unit patterns from the camera.

9. The input system using an electronic pen of claim 1, wherein,
the camera has the FOV capable of simultaneously recognizing at least more than two unit patterns, and
the controller acquires XY-axes direction data of two unit patterns from the absolute coordinate data received from the images sent by the camera, which recognize at least two unit patterns.
